(19) United States
(12) Patent Application Publication
(10) Pub. No.: US 2013/0097800 A1
(43) Pub. Date: Apr. 25, 2013

(54) WINDSCREEEN WIPER DEVICE

(71) Applicant: Xavier Boland, Arlon (BE)

(72) Inventor: Xavier Boland, Arlon (BE)

(21) Appl. No.: 13/695,146

(22) PCT Filed: Apr. 28, 2010
(86) PCT No.: PCT/EP2010/055674

§ 371 Date: Jan. 7, 2013

(51) Int. Cl. B60S 1/40

(52) U.S. Cl. CPC B60S 1/40
USPC 15/250.32; 29/428

(57) ABSTRACT

A windscreen wiper device comprising an elastic, elongated carrier element, as well as an elongated wiper blade of a flexible material, which can be placed in abutment with a windscreen to be wiped, which wiper blade includes at least one longitudinal groove, in which groove at least one longitudinal strip of the carrier element is disposed, wherein ends of the longitudinal strip are connected to respective connecting pieces, which windscreen wiper device comprises a connecting device for an oscillating arm, wherein the oscillating arm is pivotally connected to the connecting device about a pivot axis near one end thereof, with the special feature that the wiper blade is made by co-extrusion of at least two mutually differing elastomeric materials, wherein the first elastomeric material forms at least a part of an inner wall of the groove in order to lower the friction coefficient between contact surfaces of the longitudinal strip and the inner wall, and wherein the second elastomeric material forms the rest of the wiper blade.

### BACKGROUND OF THE INVENTION

1. Technical Field

The present invention relates to a windscreen wiper device comprising an elastic, elongated carrier element, as well as an elongated wiper blade of a flexible material, which can be placed in abutment with a windscreen to be wiped, which wiper blade includes at least one longitudinal groove, in which groove at least one longitudinal strip of the carrier element is disposed, which windscreen wiper device comprises a connecting device for an oscillating arm, wherein the oscillating arm is pivotally connected to the connecting device about a pivot axis near one end thereof.

2. Related Art

Such a windscreen wiper device is generally known. This prior art windscreen wiper device is designed as a so-called “flat blade” or “yokeless blade”, wherein no use is made of several yokes pivotally connected to each other, but wherein the wiper blade is biassed by the carrier element, as a result of which it exhibits a specific curvature.

### SUMMARY OF THE INVENTION

An object of the invention is to provide an improved windscreen wiper device.

In order to accomplish that objective, a windscreen wiper device of the type referred to in the introduction is characterized according to the invention in that the wiper blade is made by co-extrusion of at least two mutually differing elastomeric materials, wherein the first elastomeric material forms at least a part of an inner wall of the groove in order to lower the friction coefficient between contact surfaces of the longitudinal strip and the inner wall, and wherein the second elastomeric material forms the rest of the wiper blade. Accordingly, due to this low friction coefficient, a slight movement of the wiper blade relative to the longitudinal strip is made possible in order to allow the wiper blade to follow any curvature of the windscreen to be wiped. Further, due to this low friction coefficient, adherence (“sticking”) of the wiper blade onto the longitudinal strip in case the windscreen wiper device in practice is exposed to high temperatures, is avoided. It goes without saying that such an adherence would seriously affect the wiping properties of the wiper blade.

It is noted that the present invention is not restricted to the use of only one longitudinal strip forming the elastic carrier element that is particularly located in a central longitudinal groove or “cavity” of the wiper blade. Instead, the carrier element may also comprise two longitudinal strips, wherein the strips are disposed in opposite longitudinal grooves of the wiper blade.

The first elastomeric material particularly extends in longitudinal direction so as to form a line of contact with the longitudinal strip. In the alternative the first elastomeric material forms the entire inner wall. Also other forms of the contact would be possible.

In a preferred embodiment of a windscreen wiper device in accordance with the invention the friction coefficient is smaller than 1, preferably smaller than 0,7, more preferably smaller than 0,5.

In another preferred embodiment of a windscreen wiper device according to the invention the first elastomeric material comprises a polymer. The elastomeric material preferably is a blend of different polymers, wherein particularly a reinforcement material is added. Such a reinforcement material is in particular a low friction material, such as graphite, polypropylene (PP) powder, polyethylene (PE) powder or polytetrafluorethylene (PTFE) powder.

The invention also relates to a process for manufacturing a windscreen wiper device comprising an elastic, elongated carrier element, as well as an elongated wiper blade of a flexible material, which can be placed in abutment with a windscreen to be wiped, which wiper blade includes at least one longitudinal groove, in which groove at least one longitudinal strip of the carrier element is disposed, which windscreen wiper device comprises a connecting device for an oscillating arm, wherein the oscillating arm is pivotally connected to the connecting device about a pivot axis near one end thereof, with the special feature that the wiper blade is made by co-extrusion of at least two mutually differing elastomeric materials, wherein the first elastomeric material forms at least a part of an inner wall of the groove in order to lower the friction coefficient between contact surfaces of the longitudinal strip and the inner wall, and wherein the second elastomeric material forms the rest of the wiper blade. Particularly, an elastomeric material comprising a polymer is used.

In a preferred embodiment of a process in accordance with the invention the first elastomeric material is provided inside the material of the inner wall of the groove through a channel of an extruder die forming the groove. The elastomeric material will the chemically be bonded/linked with the second elastomeric material of the wiper blade after curing.

### THE DRAWINGS

The invention will now be explained more in detail with reference to figures illustrated in a drawing, wherein

FIG. 1 is a perspective, schematic view of a preferred embodiment of a windscreen wiper device according to the invention;

FIG. 2 is a cross-sectional view of a rubber element of a wiper blade, as used in a windscreen wiper device of FIG. 1, during manufacturing thereof; and

FIG. 3 is a cross-sectional view of a wiper blade according to a preferred embodiment.

### DETAILED DESCRIPTION

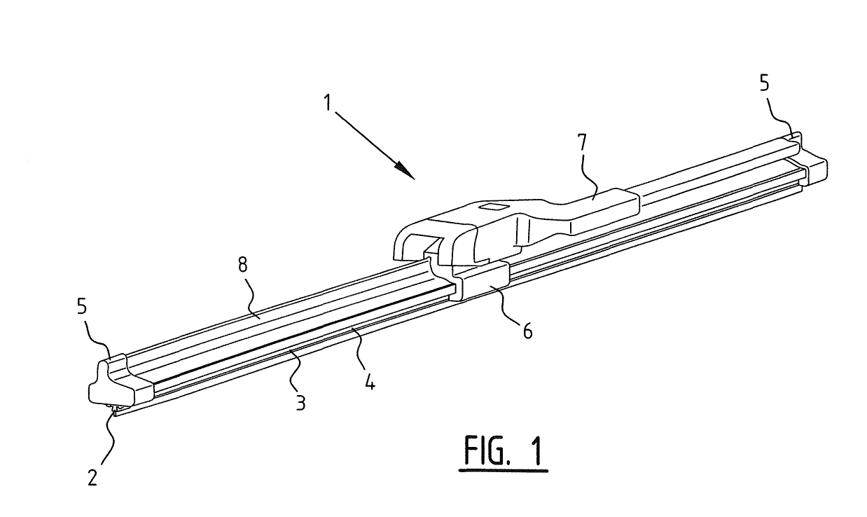

FIG. 1 shows a preferred variant of a windscreen wiper device 1 according to the invention. The windscreen wiper device is built up of an elastomeric wiper blade 2 comprising a central longitudinal groove 3, wherein a longitudinal strip or “flexor” 4 made of spring band steel is fitted in the longitudinal groove 3. The strip 4 forms a flexible carrier element for the rubber wiper blade 2, as it were, which is thus biassed in a curved position (the curvature in operative position being that of a windscreen to be wiped). An end of the strip 4 is connected on either side of the windscreen wiper device I to respective connecting pieces or “end caps” 5 functioning as closing parts. In this embodiment, the connecting pieces 5 are separate constructional elements, which may be form-locked as well as force-locked to both ends of the strip 4. In another preferred variant, the connecting pieces 5 are in one piece with the strip 4 made of spring band steel. The windscreen wiper device 1 is furthermore built up of a connecting device 6 for connecting an oscillating wiper arm 7 thereto. The oscillating wiper arm 7 is pivotally connected to the connecting device 6 about a pivot axis near one end. The preferred embodiment of FIG. 1 according to the invention comprises a spoiler or “air deflector” 8 which is made in one piece with the rubber wiper blade 2.

Although not shown in FIG. 1, but fully understood by a skilled person, the oscillating arm 7 is connected to a mounting head fixed for rotation to a shaft driven by a small motor. In use, the shaft rotates alternately in a clockwise and in a counter-clockwise sense carrying the mounting head into rotation also, which in turn draws the oscillating arm 7 into rotation and by means of the connecting device 6 moves the wiper blade 2.

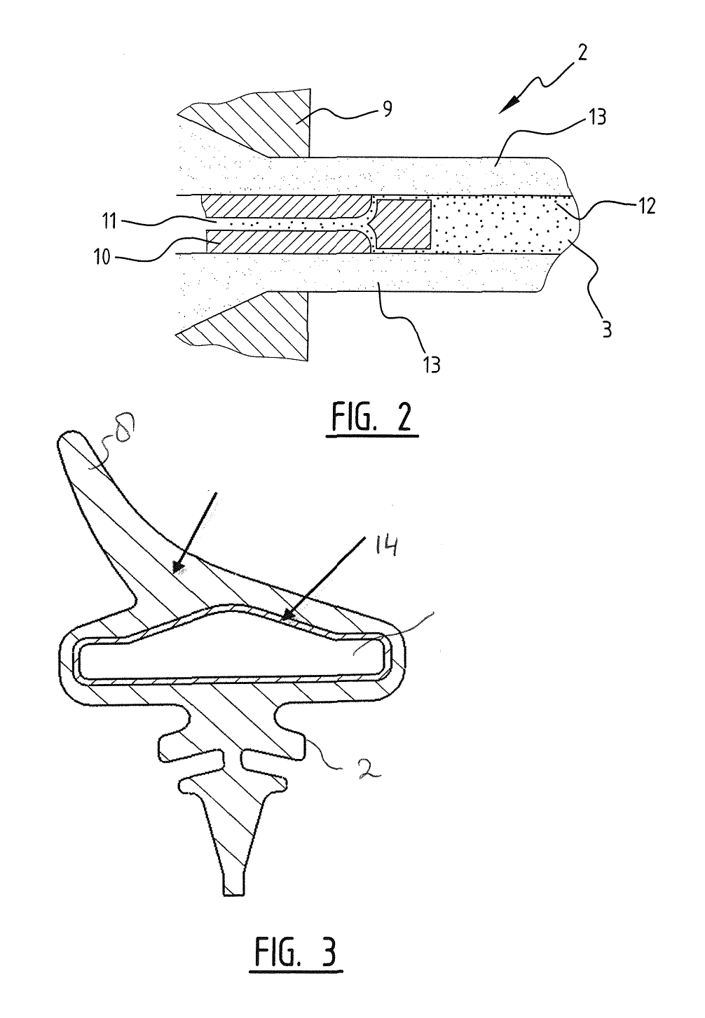

FIG. 2 shows a cross-sectional view of the wiper blade 2 of FIG. 1 during manufacturing thereof, wherein a die or mould is used having an outer part 9 and an inner part or core 10. The core 10 is meant for forming the central groove or cavity 3 for the longitudinal strip 4. The core 10 comprises a channel 11, so that a first elastomeric material 12 can be transported thereto to bond with a second elastomeric material during and after curing. The first elastomeric material forms a lining along the entire inner wall 13 of the cavity 3, wherein the second elastomeric material forms the rest of the wiper blade. The first elastomeric material comprises particles allowing a lowering of the friction coefficient between contact surfaces of the longitudinal strip 4 and the inner wall 13. Thus, a slight movement of the wiper blade 2 relative to the longitudinal strip 4 is made possible in order to allow the wiper blade 2 to follow any curvature of the windscreen to be wiped.

Adherence (“sticking”) of the wiper blade 2 onto the longitudinal strip 4 in case the windscreen wiper device 1 in practice is exposed to high temperatures, is avoided.

FIG. 3 shows a wiper blade 2, made along what is shown in FIG. 2, seen in cross section. The first elastomeric material comprising a polymer forms a lining or covering 14 along the entire inner wall 13 defining the groove 3, after the co-extrusion process. This first elastomeric material is loaded with a low friction material no as to enable a free longitudinal movement of the longitudinal strip 4 inside the groove 3 relative to the lining 14. As indicated above, the lining 14 covers the inner wall 13 in its entirety. The second elastomeric material is a standard rubber for a wiper blade 2. Co-extrusion between the first and second materials, being both polymer materials of the same family, is efficient and elegant leading to a strong bond between these materials.

The invention is not restricted to the variants shown in the drawing, but it also extends to other preferred embodiments that fall within the scope of the appended claims.

1. A windscreen wiper device comprising an elastic, elongated carrier element, as well as an elongated wiper blade of a flexible material, which can be placed in abutment with a windscreen to be wiped, which wiper blade includes at least one longitudinal groove, in which groove at least one longitudinal strip (4) of the carrier element is disposed, which windscreen wiper device comprises a connecting device for an oscillating arm, wherein said wiper blade is made by co-extrusion of at least two mutually differing elastomeric materials, wherein the first elastomeric material forms at least a part of an inner wall of said groove in order to lower the friction coefficient between contact surfaces of said longitudinal strip and said inner wall, and wherein the second elastomeric material forms the rest of said wiper blade.

2. A windscreen wiper device according to claim 1, wherein said first elastomeric material extends along a line in longitudinal direction in order to form a line of contact with said longitudinal strip.

3. A windscreen wiper device according to claim 1 wherein said first elastomeric material forms the entire inner wall.

4. A windscreen wiper device according to claim 1, wherein said friction coefficient is smaller than 1.

5. A windscreen wiper device according to claim 1, wherein said first elastomeric material comprises a polymer.

6. A windscreen wiper device according to claim 1, wherein said carrier element consists of one longitudinal strip disposed in a central longitudinal groove of said wiper blade.

7. A windscreen wiper device according to claim 1, wherein said carrier element consists of two longitudinal strips disposed in opposing longitudinal grooves of said wiper blade.

8. A process for manufacturing a windscreen wiper device comprising an elastic, elongated carrier element, as well as an elongated wiper blade of a flexible material, which can be placed in abutment with a windscreen to be wiped, which wiper blade includes at least one longitudinal groove, in which groove at least one longitudinal strip of the carrier element is disposed, which windscreen wiper device comprises a connecting device for an oscillating arm, wherein the wiper blade is made by co-extrusion of at least two mutually differing elastomeric materials, wherein the first elastomeric material forms at least a part of an inner wall of the groove in order to lower the friction coefficient between contact surfaces of the longitudinal strip and the inner wall, and wherein the second elastomeric material forms the rest of the wiper blade.

9. A process according to claim 8, wherein the first elastomeric material is provided through a channel of a mold forming the groove.

10. A process according to claim 7, wherein the first elastomeric material extends along a line extending in longitudinal direction in order to form line of contact with the longitudinal strip.

11. A windscreen wiper device according to claim 1, wherein said friction coefficient is smaller than 0.7.

12. A windscreen wiper device according to claim 1, wherein said friction coefficient s smaller than 0.5.

13. A windscreen wiper device according to claim 1, wherein said first elastomeric material comprises a blend of different polymers.
